(19) United States
(12) Patent Application Publication
(10) Pub. No.: US 2010/0100428 A1
(43) Pub. Date: Apr. 22, 2010

(54) Parking Locator

(76) Inventor: Simon Coyle, Granite Bay, CA (US)

Correspondence Address: Ken Campbell, P.O. Box 1381, Denver, CO, 80132, US

(21) Appl. No.: 12/255,162

(22) Filed: Oct. 21, 2008

(51) Int. Cl. G07B 1/00; G08B 1/08; G08G 1/123

(52) U.S. Cl. 705/13; 340/539.1; 340/932.2

(57) ABSTRACT

An apparatus and method for identifying a user's parking location in a parking facility, wherein the apparatus and method may have minimal financial impact on the users of the parking facility and the parking facility itself. The method may generally include positioning a ticket dispensing apparatus proximate a parking location of a user, and dispensing a parking location ticket from the ticket-dispensing apparatus to the user, wherein the parking location ticket contains a first side with parking location information and a second side with sponsor messages and/or advertisement information. The apparatus may generally include a ticket dispenser positioned in a parking zone of a parking facility, and removable parking location identifying tickets positioned in the ticket dispenser, wherein the parking location identifying tickets have a first side that has parking location information printed thereon and a second side that has sponsor messages and/or advertising information printed thereon.

### BACKGROUND OF THE INVENTION

1. Field of the Invention

Embodiments of the invention generally relate to an apparatus and method for locating a vehicle in a parking facility.

2. Description of the Related Art

In a large parking facility featuring one or more large lots, lots in multiple locations, or one or more parking structures (garages) with multiple levels, such as those at an airport or other public transportation facility, arena for public events, hospital or medical center, shopping center, or any other area where large numbers of vehicles are parked, it is often difficult for one who parks a vehicle in the facility to locate their vehicle when they return, as generally multiple floors, levels, zones, areas, etc., all seem to look alike to the person attempting to locate their vehicle. Often times the person parking the vehicle will attempt to note or write down a location indicator as to where their vehicle is parked; however, this process requires that the person parking the vehicle remember to do so, have a writing utensil and paper handy when they park, and finally, that the parking facility has clearly denoted parking areas that will allow the parker to easily identify the relatively small area in which their vehicle is parked. As a result, more often than not, those parking vehicles in these types of facilities do not make the proper notation of the vehicle's location, and therefore, the parker has a difficult time in locating the vehicle when they return.

Therefore, there is clearly a need for an apparatus and method for easily locating a vehicle in a parking facility, without placing significant financial strain upon the owners of the parking structure.

### SUMMARY OF THE INVENTION

Embodiments of the present invention may generally provide an apparatus and method for easily locating a vehicle in a parking facility, without placing significant financial strain upon the owners of the parking structure. More particularly, embodiments of the present invention may provide a method an apparatus for identifying a location where a vehicle is parked, wherein the method and apparatus generate a more positive experience for the consumers of the parking facility and/or provide a net revenue for the parking facility.

Embodiments of the invention may further provide a method for locating a vehicle in a parking facility. The method may generally include positioning a ticket dispensing apparatus proximate a parking location of a user, and dispensing a parking location ticket from the ticket dispensing apparatus to the user, wherein the parking location ticket contains a first side with parking location information and a second side with a sponsor's information or advertisement.

Embodiments of the invention may further provide an apparatus for determining a location of a parked vehicle. The apparatus generally includes a ticket dispenser positioned in a parking zone of a parking facility, and removable parking location identifying tickets positioned in the ticket dispenser, wherein the parking location identifying tickets have a first side that has parking location information printed thereon and a second side that has a sponsor's information or advertising information printed thereon.

Embodiments of the invention may further provide an apparatus for determining a location of a parked vehicle. The apparatus may generally include a dispensing means for dispensing paper-like items in a parking zone of a parking facility, and a removable paper-like item means for identifying a parking location positioned in the dispensing means. Generally, the removable paper-like item means for identifying a parking location will include a first side that has parking location information related to the location of the parked vehicle printed thereon and a second side that has a sponsor's message or advertising information printed thereon.

Embodiments of the invention may further provide an apparatus for determining a location of a parked vehicle. The apparatus may generally include a combination dispensing and printing means for paper-like items in a parking zone of a parking facility, and a removable paper-like item means for identifying a parking location positioned in the dispensing means. Generally, the removable paper-like item means for identifying a parking location will include a first side that has parking location information related to the location of the parked vehicle printed thereon and a second side that is blank. At any point prior to the dispensing of the aforementioned paper-like items means, the printing component of the combination dispensing and printing means prints a sponsor's message or advertising information onto the blank side of the removable paper-like item means.

### BRIEF DESCRIPTION OF THE DRAWINGS

So that the manner in which the above recited features of the present invention can be understood in detail, a more particular description of the invention, briefly summarized above, may be had by reference to embodiments thereof, some of which are illustrated in the appended drawings. It is to be noted, however, that the appended drawings illustrate only typical or exemplary embodiments of the invention, and are therefore, not to be considered limiting of its scope, for the invention may admit to other equally effective embodiments not expressly illustrated in the drawings.

FIG. 1 illustrates a front perspective view of an exemplary parking locator apparatus of the invention;

FIG. 2a illustrates a front view of an exemplary parking locator ticket of the invention;

FIG. 2b illustrates a back view of an exemplary parking locator ticket of the invention; and

FIG. 3 illustrates a flowchart of an exemplary parking locator methodology of the invention, in which printing on the removable paper-like item is prepared prior to its introduction into the dispensing means.

FIG. 4 illustrates a flowchart of an exemplary parking locator methodology of the invention, in which the printing on the removable paper-like item is prepared while that paper-like item is in the dispensing means.

FIG. 5 illustrates a flowchart of an exemplary parking locator methodology of the invention, in which the location process is carried out electronically, via a cellular phone.

### DETAILED DESCRIPTION

The present invention generally provides an apparatus and method for locating a vehicle in a parking facility, without placing significant financial strain upon the parking facility or the person parking the car in the parking facility. More particularly, embodiments of the present invention may provide a method an apparatus for identifying a parking location where a vehicle is parked in a parking facility, wherein the method and apparatus provides helpful information to the persons parking cars at the facility and increases those persons' satisfaction with the parking facility while possibly generating a net revenue for the parking facility.

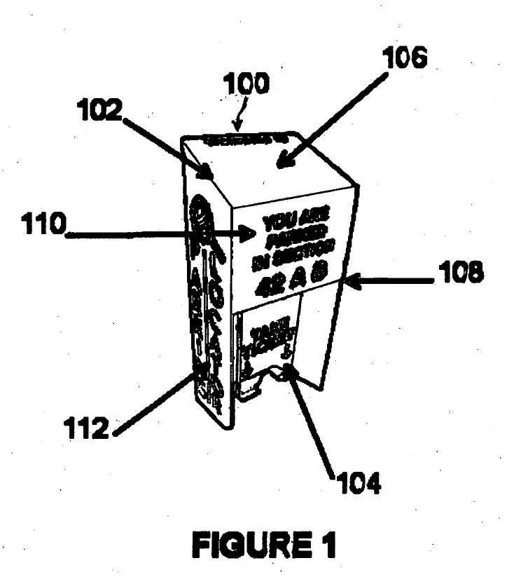

FIG. 1 illustrates a front perspective view of an exemplary parking locator apparatus 100 of the invention. The parking locator 100 generally includes a fixture that may be attached to a substantially vertical surface or support structure, or in the alternative, apparatus 100 may be a freestanding object connected to an electric power supply. The parking locator 100 generally includes a ticket dispensing receptacle 104 generally positioned on a lower surface of the parking locator 100. The receptacle 104 is generally configured to dispense a ticket, e.g., a paper or paper-like object that is generally less than about 5×7 inches, and more particularly, less than about 1×2 inches. The receptacle 104 may dispense the ticket passively, in which the user pulls the ticket from the bottom of the receptacle, or for parking locator units that also print a sponsor's message or advertising information onto the blank side of the ticket, the receptacle 104 may dispense the ticket actively after the user presses a lever or button.

The parking locator 100 generally includes an upper storage portion 102 that is configured to store additional tickets and other operational needs therein. The storage portion 102 may be in communication with the ticket dispensing receptacle 104 so that the receptacle 104 is automatically supplied tickets from the storage portion 102, thus minimizing the overhead associated with operating the parking locator 100. Additionally, the storage portion 102 is sized to generate a plurality of advertising or informational surfaces for the parking locator 100. For example, of the six sides of the exemplary parking locator illustrated in FIG. 1, four of the sides may be used for advertising, user location identification, or user awareness messages. More particularly, the top portion of the storage portion 106, the left side of the storage portion 112, the right side of the storage portion 108, and the front portion of the storage portion 110 may all be used for advertising or user awareness messages. In the exemplary embodiment of the invention illustrated in FIG. 1, the advertising surfaces 106, 108, 110, and 112 of the parking locator 100 are used to identify the parking locator 100 and its respective location in the parking facility. More particularly, the parking locator 100 illustrated in FIG. 1 illustrates the parking section on the front surface 110, and illustrates an awareness message on the side surface 112, i.e., the awareness message is the “Parking Locator” indicator that indicates the presence of the machine. The parking locators are generally presented in bright and/or vibrant colors, i.e., yellow or orange, for example, so as to stand out from other objects normally present in a parking facility.

Additionally, although not expressly illustrated in FIG. 1, the parking locator may include a device for indicating that the ticket receptacle 104 is out of tickets. The device may include, for example, a flag or indicator light on the parking locator 100 that visually illustrates that the ticket receptacle 104 is out of tickets. In another embodiment of the invention, the parking locator 100 may include a power source and an electronic sensor configured to determine when the ticket receptacle is out or low on tickets. The electronic sensor may communicate with a microprocessor that is configured to control a signal that indicates that the ticket receptacle 104 is out of tickets. The signal may, for example, include an LED or light that indicates the ticket status, or alternatively, the signal may be a control signal for a radio or cellular transmitter that is also in communication with the power source. The transmitter may be configured to send a signal to another location where the signal is received and a person is dispatched to refill the tickets in response to the signal. The sensor and signaling device may or may not appear in the parking locator unit in combination with the ticket-printing components.

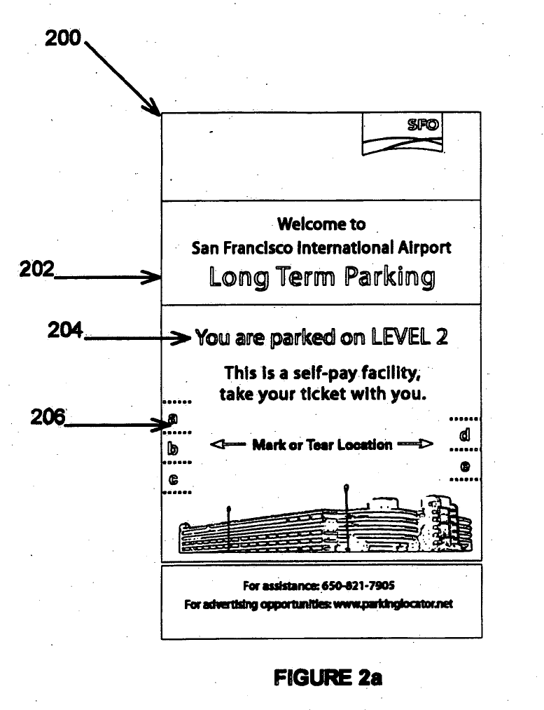

FIG. 2a illustrates a front view of an exemplary parking locator ticket 200 of the invention. The parking locator ticket 200 generally includes a plurality of location indicia or indicators, such as first location indicator 202, second location indicator 202, and third location indicator 204. Additionally, parking locator ticket 200 may include a selectable parking location indicator 206. The selectable parking location indicator 206 may be a tearable portion or a hole punch location that may be customized to represent a more precise parking location of a users vehicle. For example, in the exemplary parking location ticket 200 illustrated in FIG. 2a, the selectable parking location indicator 206 may be a location in the side of the ticket 200 that may be torn by the user to correspond to a particular parking location, e.g., “a,” “b,” or “c.” In the case of a parking locator unit equipped with the printing option, the ticket location indicator 206 may be printed immediately prior to dispensing.

FIG. 2b illustrates a back side view of an exemplary parking locator ticket of the invention. The backside of the ticket generally includes at least one sponsored message or advertisement 220. The message or advertisement may, for example, be for services related to the parking location, i.e., advertisements in an airport parking garage may be related to air travelers needs. The advertisements positioned on the tickets are an important feature of the invention, as the advertisements allow for the parking locator to increase customer satisfaction with the parking facility and/or generate revenue, while not causing a negative financial impact upon the parking facility. Sponsored messages may be from the facility itself promoting its own events or branding, may be from not-for-profit organizations, or may be from advertisers. Any revenue is derived from the fees advertisers pay for having their advertisement on the back of the tickets. Thus, the advertisements on the tickets allow the parking locator to provide parking location information to users of the parking facility, while not having a negative financial impact on the parking facility. In fact, advertising revenue derived from the advertisements placed on the back of the locator tickets may provide a positive financial impact on the parking facility as a result of the money made from the advertisements.

Taken in toto, the ticket potentially increases customer satisfaction with the parking facility by providing parking location information for the customer's vehicle directly to the customer. The parking facility also benefits by the space allowed for its own messages, or may choose to lease the space 220 to advertisers directly or via an agent. Advertisers benefit from access to the facility's customers and the association of the advertising branding or message with the facility customers' increased satisfaction with their parking experience.

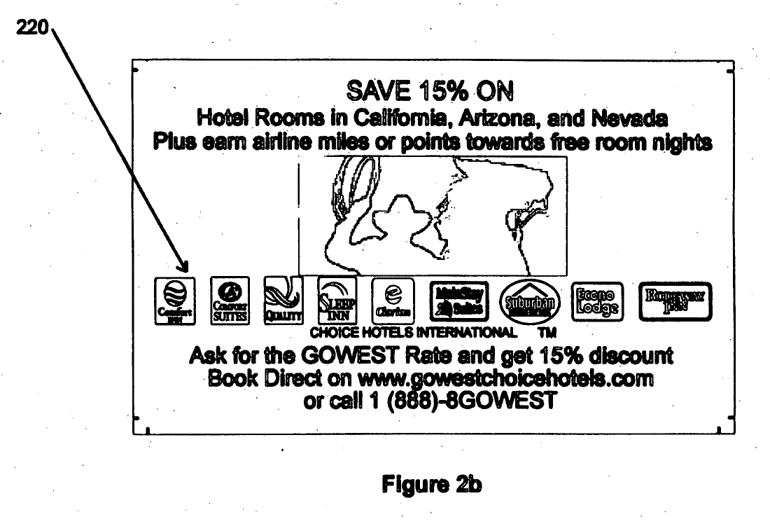

FIG. 3 illustrates a flowchart of an exemplary parking locator methodology of the invention. The method begins at step 300, and continues to step 302, where the parking locator box is positioned in the parking facility. Generally, the parking locator box is positioned in a location that is central to a plurality of parking spaces. For example, the plurality of parking spaces may be a portion of a parking garage floor or a zone of a parking lot. Once the parking box is positioned in the particular parking facility location, then the method continues to step 304, where the front portion of the parking locator ticket is generated. Generally, the front portion of the ticket includes the parking location information, such as the parking level, floor, zone, space number, area, color, lot, etc.; and may contain further site-specific information such as telephone numbers for security or vehicle assistance. Additionally, the front portion of the parking ticket also includes a selectable portion. The selectable portion of the ticket allows the user to modify the ticket to particularly or specifically identify a parking spot location. An exemplary method for the user to modify the ticket includes tearing the edge of the ticket in a predetermined location that corresponds to the specific parking location of the user. Other exemplary methods for modifying the ticket include a punch card area (where the user or a machine may be used to punch a marker into the ticket that identifies the specific parking location), a space for the user to write a specific parking location, etc.

The method continues to step 306, where the parking locator ticket backs are generated. The parking locator backs include sponsor messaging and/or advertising indicia selected to target the patrons using the parking facility in which the tickets are dispensed. Advertisers are generally contracted to purchase advertising space on the ticket backs. Once the ticket front surfaces and back surfaces are generated and printed on the tickets, the parking locator boxes are filled with the tickets that correspond to the parking facility in which the parking locator box is positioned, which is illustrated at step 308.

At step 310 in the exemplary method of the invention, the parking locator tickets are dispensed from the parking locator boxes at the parking facility. As noted above, the parking locator boxes are strategically positioned throughout the parking facility so that the particular tickets placed in each of the parking locator boxes have location indicators thereon that accurately represent the parking location of the user, i.e., the user will take a parking locator ticket from the closest parking locator box to their parking space, and the ticket will generally have location information for the location of the box that is proximate their vehicle. At step 312 of the exemplary method of the invention, the parking locator boxes are refilled with tickets as needed. The refilling operation may be on a predetermined schedule, or in response to an indication that the box is low on tickets. The indication, for example, may come from an indicator on the parking locator box itself, or alternatively, the parking locator box may be fitted with a sensor and transmitter that communicates the parking locator box's need for replacement tickets to a remote location, where coordination of the ticket restocking may be executed.

At step 314 of the exemplary method of the invention, the previously recited steps may be repeated for multiple locations within a particular parking facility. For example, in an airport parking garage, there may be several floors of parking, and each floor may have several large zones for parking therein. In this situation, at least one parking locator box may be positioned in each parking zone on each floor of the parking facility. Therefore, each floor of the parking facility may have several of the parking locator boxes, so that when a user exits their vehicle, a parking locator box is generally only a short distance away. Additionally, the parking locator boxes are generally positioned proximate the user's egress path from the parking facility. More particularly, the parking locator boxes are generally positioned between where a user parks and the exit to the parking facility, so that the user does not have to go out of their way to collect a ticket from the parking locator box. Further, as noted above, the parking locator ticket may have a selectable parking location indicia thereon, such as a corrugated punch out tab, a tear indicator, or a writing space, for example, that a person parking a vehicle may use to identify the specific parking location of their vehicle.

Thereafter, at step 316, the exemplary method of the invention ends. However, the inventors note that the methodology of the invention is not limited to the particular sequence of method steps noted in the exemplary method. Rather, the method presented in FIG. 3 is intended to be exemplary, and as such, the method steps may be conducted in various sequences without departing from the scope of the invention.

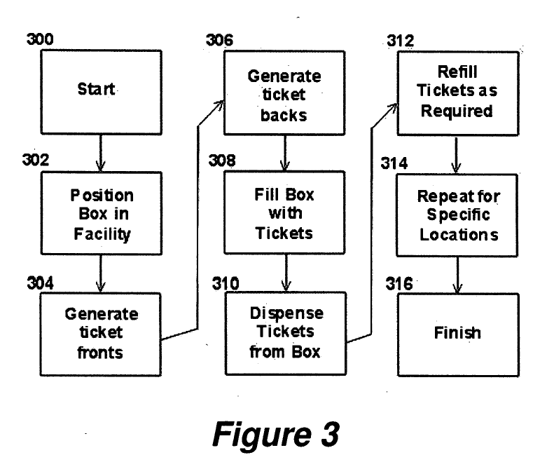

FIG. 4 illustrates a flowchart of an additional exemplary parking locator methodology of the invention, in which the parking locator box for dispensing tickets contains a means for printing on the tickets. The method begins at step 400, and continues to step 402, where the parking locator box is positioned in the parking facility. Generally, the parking locator box is positioned in a location that is central to a plurality of parking spaces. For example, the plurality of parking spaces may be a portion of a parking garage floor or a zone of a parking lot. Once the parking box is positioned in the particular parking facility location, then the method continues to step 404, where the front portion of the parking locator ticket is generated. Generally, the front portion of the ticket includes the parking location information, such as the parking level, floor, zone, space number, area, color, lot, etc.; and may contain further site-specific information such as telephone numbers for security or vehicle assistance. Additionally, the front portion of the parking ticket also includes a selectable portion. The selectable portion of the ticket allows the user to modify the ticket to particularly or specifically identify a parking spot location. An exemplary method for the user to modify the ticket includes tearing the edge of the ticket in a predetermined location that corresponds to the specific parking location of the user. Other exemplary methods for modifying the ticket include a punch card area (where the user or a machine may be used to punch a marker into the ticket that identifies the specific parking location), a space for the user to write a specific parking location, etc. Through its printing device, the parking locator box itself may contain means to indicate the specific parking location of the user prior to dispensing 410.

The method continues to step 406, where the parking locator boxes are filled with the tickets that correspond to the parking facility in which the parking locator box is positioned.

The method continues to step 408, where the parking locator ticket backs are generated by means of the printer contained within the parking locator box. Usually printing will be done immediately prior to a ticket being dispensed to the user at 410. Printing on the parking locator backs may include sponsor messaging and/or advertising indicia selected to target the patrons using the parking facility in which the tickets are dispensed. Advertisers are generally contracted to purchase advertising space on the ticket backs. Once the back surfaces are printed on the tickets, the parking locator boxes are ready for dispensation to customers in 410.

At step 410 in the exemplary method of the invention, the parking locator tickets are dispensed from the parking locator boxes at the parking facility. As noted above, the parking locator boxes are strategically positioned throughout the parking facility so that the particular tickets placed in each of the parking locator boxes have location indicators thereon that accurately represent the parking location of the user, i.e., the user will take a parking locator ticket from the closest parking locator box to their parking space, and the ticket will generally have location information for the location of the box that is proximate their vehicle. At step 412 of the exemplary method of the invention, the parking locator boxes are refilled with tickets as needed. The refilling operation may be on a predetermined schedule, or in response to an indication that the box is low on tickets. The indication, for example, may come from an indicator on the parking locator box itself, or alternatively, the parking locator box may be fitted with a sensor and transmitter that communicates the parking locator box's need for replacement tickets to a remote location, where coordination of the ticket restocking may be executed.

At step 414 of the exemplary method of the invention, the previously recited steps may be repeated for multiple locations within a particular parking facility. For example, in an airport parking garage, there may be several floors of parking, and each floor may have several large zones for parking therein. In this situation, at least one parking locator box may be positioned in each parking zone on each floor of the parking facility. Therefore, each floor of the parking facility may have several of the parking locator boxes, so that when a user exits their vehicle, a parking locator box is generally only a short distance away. Additionally, the parking locator boxes are generally positioned proximate the user's egress path from the parking facility. More particularly, the parking locator boxes are generally positioned between where a user parks and the exit to the parking facility, so that the user does not have to go out of their way to collect a ticket from the parking locator box. Further, as noted above, the parking locator ticket may have a selectable parking location indicia thereon, such as a corrugated punch out tab, a tear indicator, or a writing space, for example, that a person parking a vehicle may use to identify the specific parking location of their vehicle.

Thereafter, at step 416, the exemplary method of the invention ends. However, the inventors note that the methodology of the invention is not limited to the particular sequence of method steps noted in the exemplary method. Rather, the method presented in FIG. 4 is intended to be exemplary, and as such, the method steps may be conducted in various sequences without departing from the scope of the invention.

Therefore, the inventors submit that the parking locator is an innovative concept designed to create an easier parking experience for patrons of various parking facilities. The parking locator ticket boxes are strategically placed throughout parking lots in easy view of the patrons of the parking facility. The parking locator tickets may generally include: map location of vehicle in correlation to building; access numbers such as security customer service, tow companies, lock-outs and jump starts; and upcoming promotions and advertisements. The parking facilities benefit from the invention as a result of: Increased customer satisfaction; reduction of wasted employee time; and increased security efficiency.

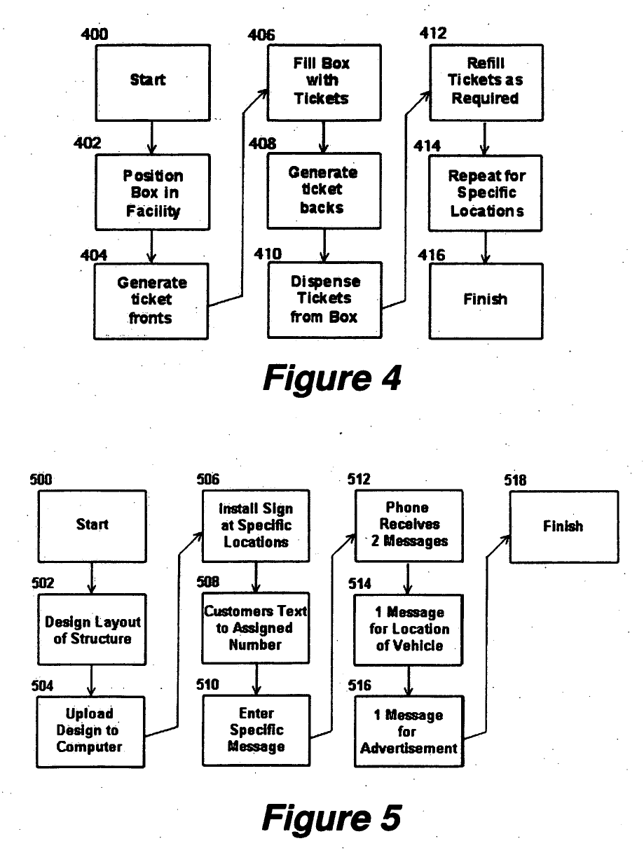

FIG. 5 illustrates a flowchart of yet another exemplary parking locator methodology of the invention, in which the parking locator box for dispensing tickets, which advise the user to enter a particular text message on his cell phone, to a pre-assigned text message number corresponding to the location of that parking locator box. The text initiates a reply to the user's cell phone, which contains information about the location of the parking area and/or exact parking stall. A second reply to the original text message from the user contains advertising information. This method may include a third reply, a fourth reply, and so on. Each additional reply may contain other useful information regarding additional advertisers or the parking locator system itself.

The method begins at Step 500 and continues to Step 502, where the layout of the parking structure is taken into consideration. At Step 504, the layout information is uploaded to a computer system, which coordinates incoming and outgoing messages. Step 506 installs a sign at a specific parking area, and informs users of a particular cell text number for that corresponding location.

As a user prepares to leave the parking area, Step 508 marks the process of initiating a text message to the assigned text number for that area. At Step 510, the user enters a specific text message, which triggers an appropriate set of replies containing useful information.

Step 512 indicates the step where the computer system sends a set of replies to the user's cell phone. Step 514 indicates that one of the replies contains information about the location of the vehicle (analogous to the information provided on a ticket, in other embodiments). Step 516 indicates that at least one other reply is sent to the user's cell phone, which contains information from advertisers. Step 518 indicates the end of the process, which may be repeated indefinitely.

While the foregoing is directed to embodiments of the present invention, other and further embodiments of the invention may be devised without departing from the basic scope thereof, and the scope thereof is determined by the claims that follow.

1. A method for locating a vehicle in a parking facility, comprising:
positioning a ticket dispensing apparatus proximate a parking location of a user; and
dispensing a parking location ticket from the ticket dispensing apparatus to the user, wherein the parking location ticket contains a first side with parking location information and a second side with sponsor messages or advertisement information.

2. The method of claim 1, further comprising modifying the ticket, by the user or by the dispensing apparatus, to specifically identify the parking location of the user.

3. The method of claim 2, wherein the modifying comprises the user activating a punch card or a tear strip on the parking location ticket, wherein the punch card or tear strip generates an indicia of the parking location of the user on the parking location ticket.

4. The method of claim 1, wherein positioning the ticket dispensing apparatus comprises positioning a plurality of ticket dispensing apparatuses in a parking facility, wherein each of the ticket dispensing apparatuses corresponds to a particular parking zone of the parking facility that contains a predetermined number of parking spaces.

5. The method of claim 1, further comprising placing sponsor messages or paid advertisements on outer surfaces of the parking locator apparatus to generate revenue.

6. The method of claim 5, wherein the advertisements on the parking location tickets are sold to advertisers in exchange for revenue.

7. The method of claim 1, further comprising determining when the parking location apparatus is low on tickets and replenishing the tickets.

8. The method of claim 7, wherein the determining step further comprises sensing a ticket quantity in the parking location apparatus and sending a radio or cellular signal to a remote location indicating that the ticket quantity is low.

9. An apparatus for determining a location of a parked vehicle, comprising:
a ticket dispenser positioned in a parking zone of a parking facility; and
removable parking location identifying tickets positioned in the ticket dispenser, wherein the parking location identifying tickets have a first side that has parking location information related to the location of the parked vehicle printed thereon and a second side that has sponsor messages or advertising information printed thereon.

10. The apparatus for determining a location of a parked vehicle recited in claim 9, further comprising a user selectable parking location indicia on the parking location identifying tickets.

11. The apparatus for determining a location of a parked vehicle recited in claim 10, wherein the user selectable parking location indicia comprises a tear strip that corresponds to the location of the parked vehicle.

12. The apparatus for determining a location of a parked vehicle recited in claim 10, wherein the user selectable parking location indicia comprises a plurality of perforated areas that may be punched out by the user, each of the perforated areas corresponding to a specific parking location or parking zone.

13. The apparatus for determining a location of a parked vehicle recited in claim 10, wherein the user selectable parking location indicia is generated by the apparatus prior to or at the point of dispensing the ticket to the user.

14. The apparatus for determining a location of a parked vehicle recited in claim 9, wherein the ticket dispenser comprises at least four outer surfaces configured to receive advertisements.

15. The apparatus for determining a location of a parked vehicle recited in claim 9, wherein the ticket dispenser is positioned between the location of the parked vehicle and an egress from a parking facility containing the location of the parked vehicle.

16. An apparatus for determining a location of a parked vehicle, comprising:
dispensing means for dispensing paper-like items in a parking zone of a parking facility; and
removable paper-like item means for identifying a parking location positioned in the dispensing means, wherein the removable paper-like item means for identifying a parking location have a first side that has parking location information related to the location of the parked vehicle printed thereon and a second side that has advertising information printed thereon.

17. The apparatus for determining a location of a parked vehicle recited in claim 16, further comprising a means for a user to select parking location indicia representative of the parking location positioned on the first side of the means for identifying a parking location.

18. The method of claim 1, further comprising the parking locator apparatus physically printing sponsor messages or paid advertisements on parking location tickets to generate revenue.

19. A method for locating a vehicle in a parking facility, comprising:
positioning a sign proximate a parking location of a user; and
coordinating an exchange of cell phone text messages between the user and a computer system, so as to identify the location of the parking facility for the user.
